(19) United States
(12) Patent Application Publication
(10) Pub. No.: US 2023/0320526 A1
(43) Pub. Date: Oct. 12, 2023

(54) COOKING APPARATUS WITH GRILL AND HEATED AIR FLOW FUNCTIONS

(71) Applicant: CONAIR LLC, STAMFORD, CT (US)

(72) Inventors: KYLE ERIK LINDELL, FAIRFIELD, CT (US); JAMES A. SANDOR, TRUMBULL, CT (US); LUKE JOHNSON, SHELTON, CT (US)

(73) Assignee: CONAIR LLC, STAMFORD, CT (US)

(21) Appl. No.: 17/716,014

(22) Filed: Apr. 8, 2022

(51) Int. Cl. A47J 37/06

(52) U.S. Cl. CPC A47J 37/0641; A47J 37/0611; A47J 37/0664

(57) ABSTRACT

A cooking apparatus includes a lower housing having a lower heating surface, an upper housing having an upper heating surface, and a fan assembly configured to direct a flow of heated air into a space between the upper heating surface and the lower heating surface.

### FIELD OF THE INVENTION

The present invention relates to cooking appliances and, more particularly, to double contact grill having both grilling and heated air flow functions.

### BACKGROUND OF THE INVENTION

Cooking appliances, and in particular electric cooking/grilling devices such as double contact grills, are known. One type of known double contact grilling device typically evidences a lower housing having a lower cooking surface and an upper housing having an upper cooking surface, wherein the cooking surfaces are typically heated by an electrical resistance heater. A handle attached to the upper housing allows a user to raise and lower the upper housing relative to the lower housing to accommodate a food item therebetween, to be heated.

While existing grilling devices are generally suitable for what is regarded as ordinary performance, there is room for improvement in terms of the ability to provide multiple cooking functions in a single device. For example, existing double contact grilling devices are typically configured to provide grilling functionality via direct contact of a food item with a cooking surface, but are otherwise not suited to provide other cooking functions or modes of operation, such as convection cooking, baking or air frying.

Accordingly, there is a need for a cooking appliance in the form of a double contact grill that is capable of both cooking food items via direct contact with a food item, as well as through circulation of heated air around a food item.

### SUMMARY OF THE INVENTION

It is an object of the present invention to provide a cooking appliance having both grilling and heated air flow cooking functions.

It is an object of the present invention to provide a double contact grill having both grilling and heated air flow cooking functions.

It is another object of the present invention to provide a double contact grill having a removable cooking chamber.

These and other objects are achieved by the present invention.

According to an embodiment of the present invention a cooking appliance includes a lower housing having a lower heating surface, an upper housing having an upper heating surface, and a fan assembly configured to direct a flow of heated air into a space between the upper heating surface and the lower heating surface.

According to another embodiment of the present invention a method for operating a cooking appliance includes positioning a frame assembly intermediate a lower heating surface and an upper heating surface, the frame assembly defining a cooking cavity, fluidly connecting the cooking cavity with a fan assembly, and actuating a fan of the fan assembly to generate a flow of air into the cooking cavity.

According to yet another embodiment of the present invention, a cooking appliance includes a lower housing having a lower heating surface, an intake vent, an air plenum in fluid communication with the intake vent, and at least one heating element associated with the air plenum, an upper housing having an upper heating surface and moveable with respect to the lower housing, and a fan assembly configured to initiate a flow of air into the air plenum through the intake vent, across the at least one heating element, and into a space intermediate the lower heating surface and the upper heating surface.

### BRIEF DESCRIPTION OF THE DRAWINGS

The present invention will be better understood from reading the following description of non-limiting embodiments, with reference to the attached drawings, wherein below:

FIG. 1 is a front, perspective view of a cooking apparatus according to an embodiment of the present invention, showing an upper housing in an open position.

FIG. 2 is a bottom, perspective view of the cooking apparatus of FIG. 1.

FIG. 3 is another front, perspective view of the cooking apparatus of FIG. 1, showing the upper housing in a closed position.

FIG. 4 is a rear, perspective view of the cooking apparatus of FIG. 1, showing the upper housing in a closed position.

FIG. 5 is a front elevational view of the cooking apparatus of FIG. 1.

FIG. 6 is a top plan view of the cooking apparatus of FIG. 1.

FIG. 7 is a front, perspective view of the cooking apparatus of FIG. 1, shown with the upper and lower heating surfaces removed.

FIG. 8 is an enlarged, perspective view of a lower housing of the cooking apparatus of FIG. 1.

FIG. 9 is a front, perspective view of the cooking apparatus FIG. 1, shown with the upper heating surface removed.

FIG. 10 is a front elevational view of the cooking apparatus of FIG. 1, shown with the upper heating surface removed.

FIG. 11 is a rear, perspective view of the cooking apparatus of FIG. 1, shown in the open position.

FIG. 12 is a top plan view of the cooking apparatus of FIG. 1, shown in the open position.

FIG. 13 is a perspective view of a fan assembly of the cooking apparatus of FIG. 1.

FIG. 14 is a front, perspective view of a frame assembly of the cooking apparatus of FIG. 1.

FIG. 15 is a rear, perspective view of the frame assembly of FIG. 14.

FIG. 16 is a top plan view of the frame assembly of FIG. 14.

FIG. 17 is a left side elevational view of the frame assembly of FIG. 14.

FIG. 18 is a front, perspective view of the frame assembly of FIG. 14, shown with the front wall removed.

FIG. 19 is a left side elevational view of the frame assembly of FIG. 14, shown with the front wall removed.

FIG. 20 is a top plan view of the frame assembly of FIG. 14, shown with the front wall removed.

FIG. 21 is a side, schematic illustration of a portion of the cooking apparatus, showing connection of the frame assembly with the fan assembly.

FIG. 22 is another side, schematic illustration of a portion of the cooking apparatus, showing connection of the frame assembly with the fan assembly.

FIG. 23 is a side, cross-sectional illustration of the cooking apparatus of FIG. 1, showing the air flow pathway therethrough.

### DETAILED DESCRIPTION OF THE PREFERRED EMBODIMENTS

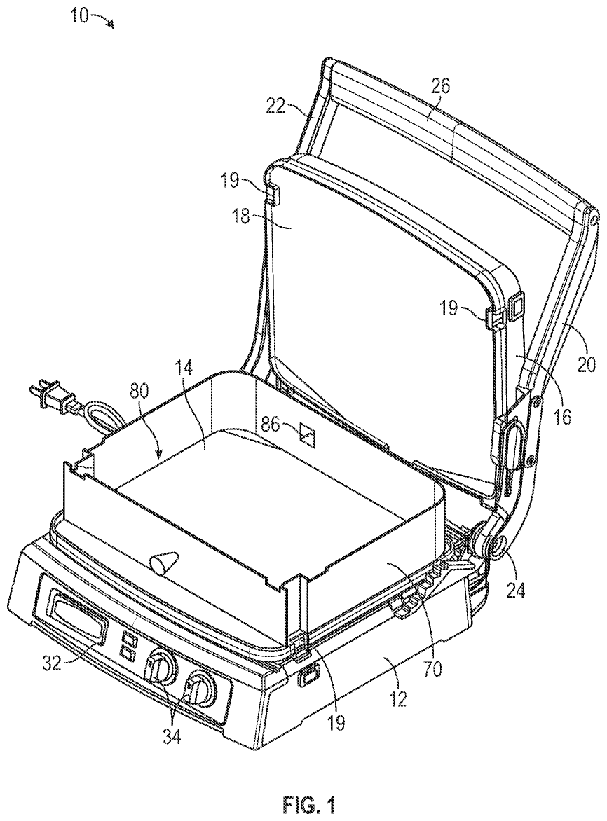

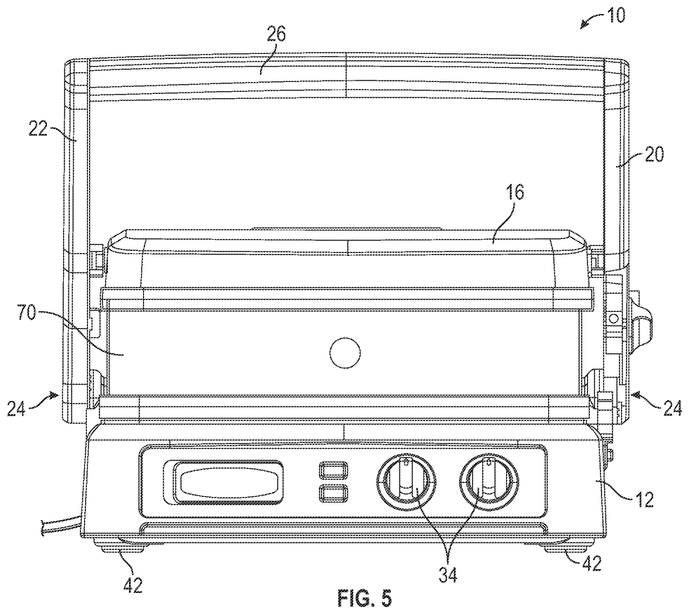

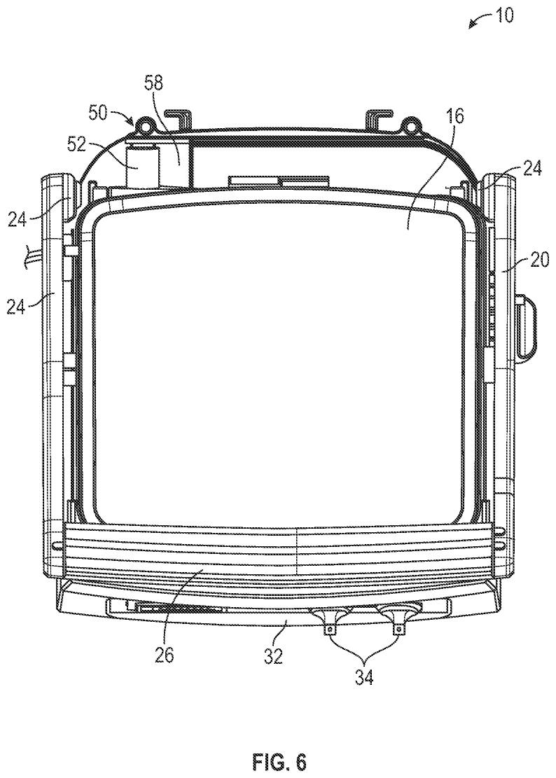

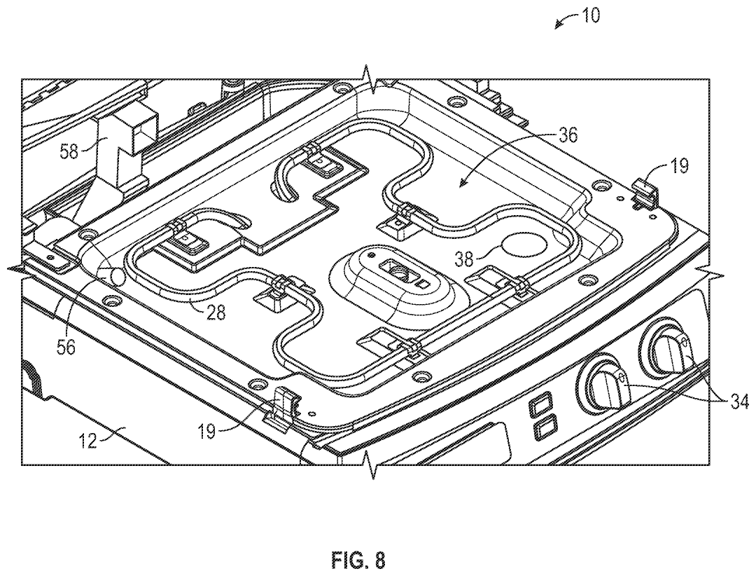

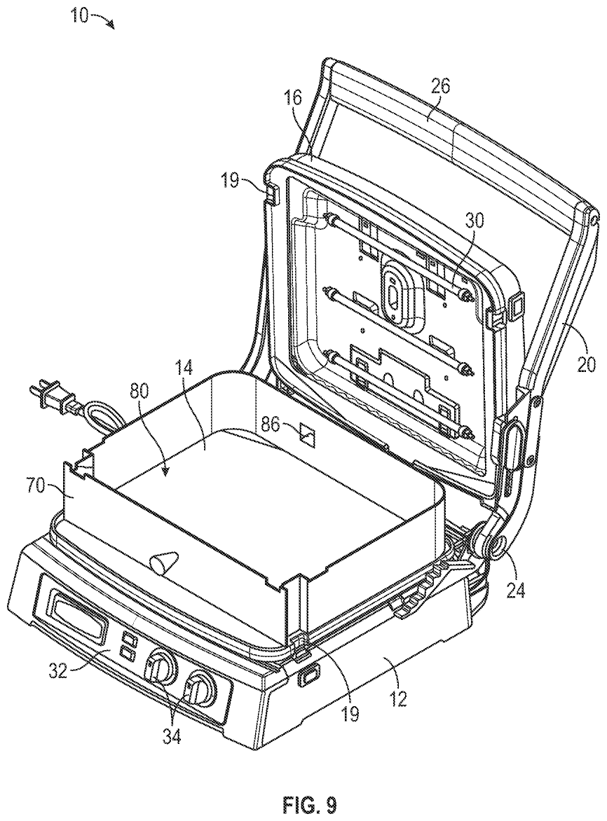

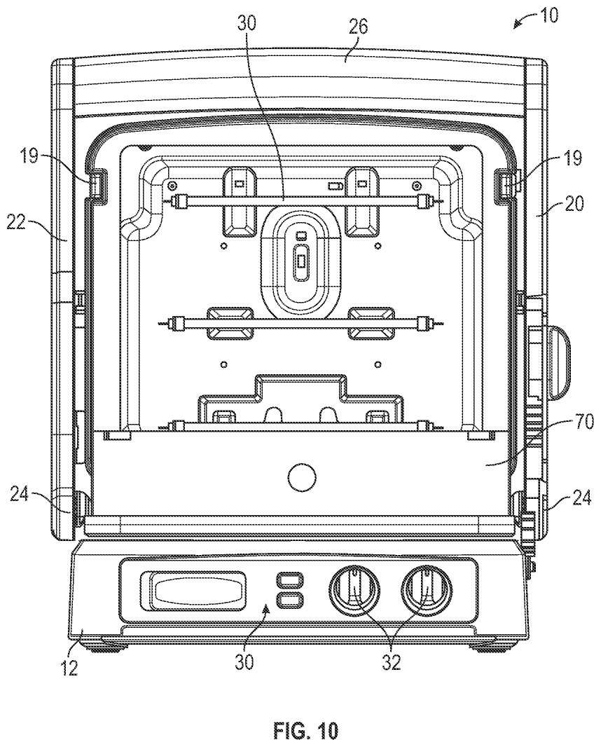

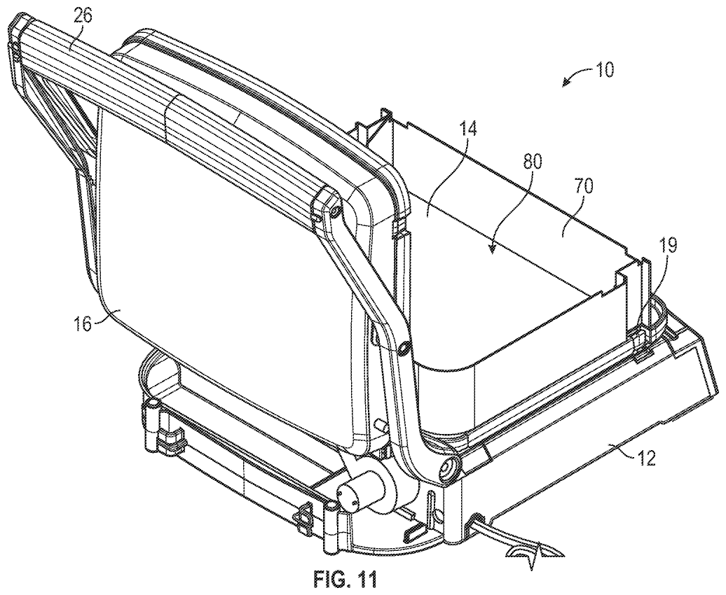

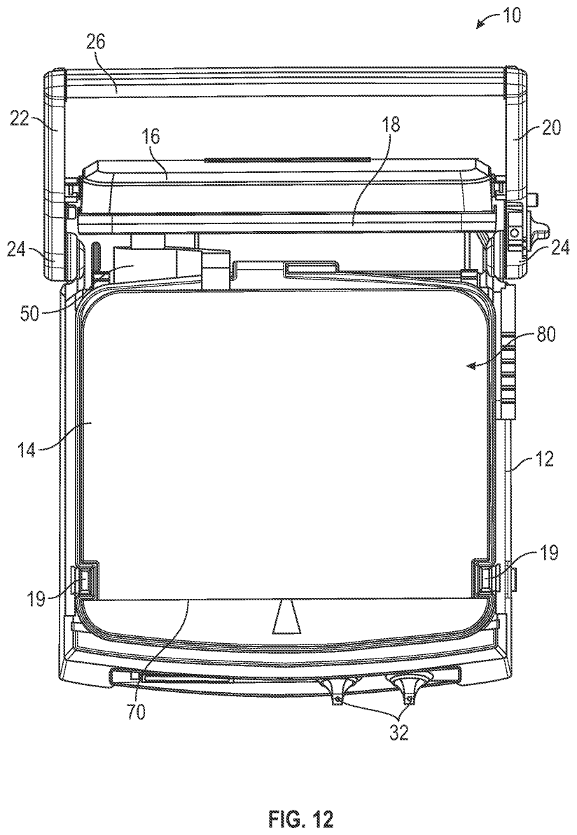

Referring to FIGS. 1-12, a cooking apparatus 10 according to an embodiment of the present invention is shown. The cooking apparatus 10 generally takes the form of a countertop, double contact grill having a lower housing 12 that supports a lower heating surface 14 or cooking plate, and an upper housing 16 that supports an upper heating surface 18 or cooking plate. In this embodiment, the lower and upper heating surfaces 14, 18 are shown as being flat although one or both of them may also be provided with ribs. In an embodiment, the upper and lower heating surfaces may be formed from metal, such as aluminum, or glass, although other materials known in the art may also be utilized without departing from the broader aspects of the invention. The lower and upper heating surfaces 14, 18 may be removable from the lower housing 12 and upper housing 16, respectively. For example, in an embodiment, the upper and lower housings 12, 16 may include a plurality of resilient retention elements 19 (e.g., resilient clips) that function to retain the heating surfaces 14, 18 on the lower housing 12 and upper housing 16, respectively.

As shown in FIGS. 1-12, the upper housing 16 is carried by opposed frame members 20, 22 and is pivotally connected to the lower housing 12 via a rear hinge 24. A handle 26 is attached to the upper housing 16 and allows a user to raise and lower the upper housing 16, via rotation about the hinge 24, in order to selectively position the upper housing 16 in various positions in relation to the lower housing 12.

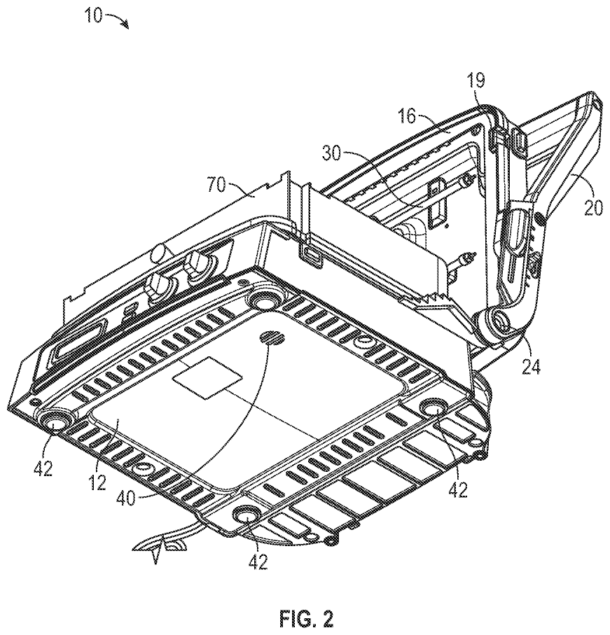

As best shown in FIGS. 2, 7 and 8, the lower housing 12 and upper housing 16 are each configured with one or more heating elements 28, 30, respectively. The heating elements 28, 30 may be of any type known in the art, and are configured to generate heat, which is then transferred to the respective heating surfaces 14, 18 positioned in close association with, or in contact with the heating elements 28, 30, for elevating the temperature of the heating surfaces 14, 18. It is contemplated, however, that the heating elements 28, 30 may be embedded in the heating surface 14, 18.

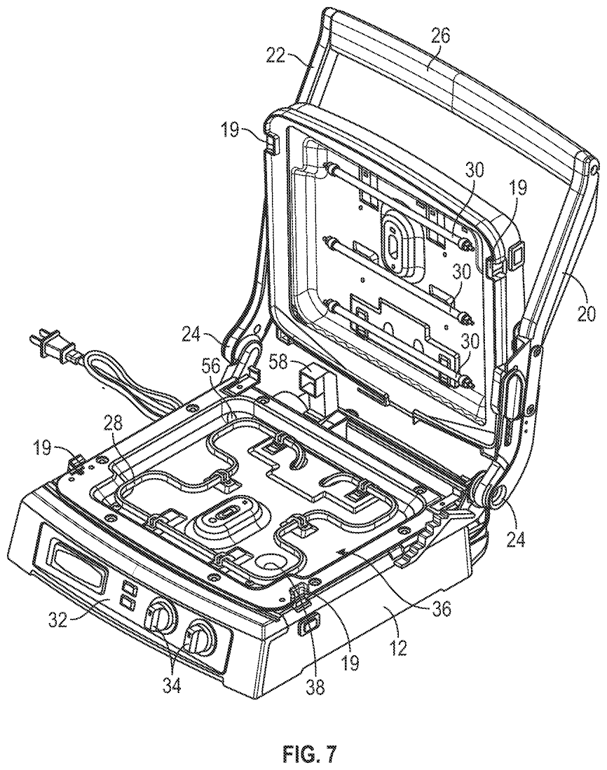

As illustrated in FIG. 7, in an embodiment, the lower housing 12 includes a recessed area 36 within which the lower heating element 28 is positioned. When the lower heating surface 14 is received on the lower housing, the recessed area 36 defines a plenum between the underside of the lower heating surface 14 and the lower housing 12 (within which the lower heating element(s) is located, the purposes of which will be described hereinafter. An air inlet 38 is formed in the lower housing 12, which provides for ingress of air into the plenum, as also described hereinafter. The air inlet 38 is in fluid communication with an intake vent 40 formed in the bottom of the lower housing 12 (best shown in FIG. 2), although it is contemplated that the intake vent 40 may also be formed in a sidewall or rear of the lower housing 12 without departing from the broader aspects of the invention. In an embodiment, the lower housing 12 includes a plurality of feet 42 configured to elevate the lower housing 12 above a countertop of other surface, as also shown in FIG. 2, which enables a flow of air to enter the intake vent 40 from below.

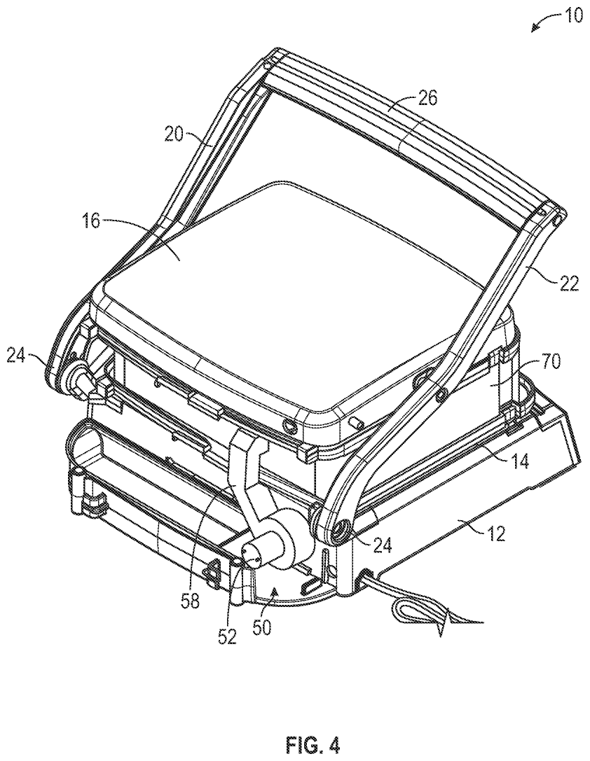

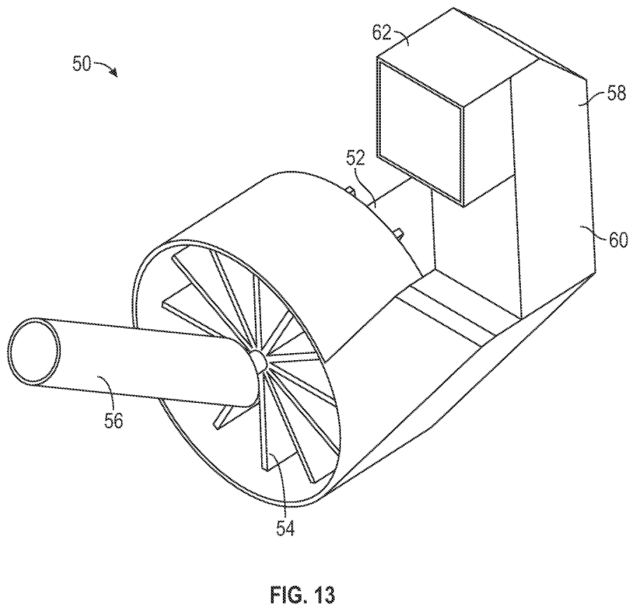

With particular reference to FIG. 4, the cooking apparatus 10 also includes a fan assembly 50 located at the rear of the lower housing 12. The fan assembly 50 includes a motor 52 and a fan or impeller 54 drivingly connected to the motor. The fan assembly 50 also includes a fan inlet duct 56 that is in fluid communication with the air plenum 36 in the lower housing 12, and a fan outlet duct 58 that extends above the lower heating surface 16. A more detailed illustration of the fan assembly 50 is shown in FIG. 13. As shown therein, the fan outlet duct 58 has a first leg portion 60 that extends generally vertically, and a second leg portion 62 extending approximately perpendicularly from the first leg portion 60 towards the front of the cooking apparatus 10. The fan inlet duct 56 extends at a generally upward angle from the fan 54.

Referring back to FIGS. 1 and 2, the cooking apparatus 10 includes a control panel 32 having an array of buttons and/or rotatable knobs 34 that allow a user to select and set a variety of cooking and heating parameters such as, for example, a temperature of one or both of the heating surfaces 14, 18, the motor 52 of the fan assembly 50 (on/off and/or speed), etc. In another embodiment, the fan assembly 50 may have a dedicated switch for turning the motor 52 on and off and/or for controlling the speed of the fan 54.

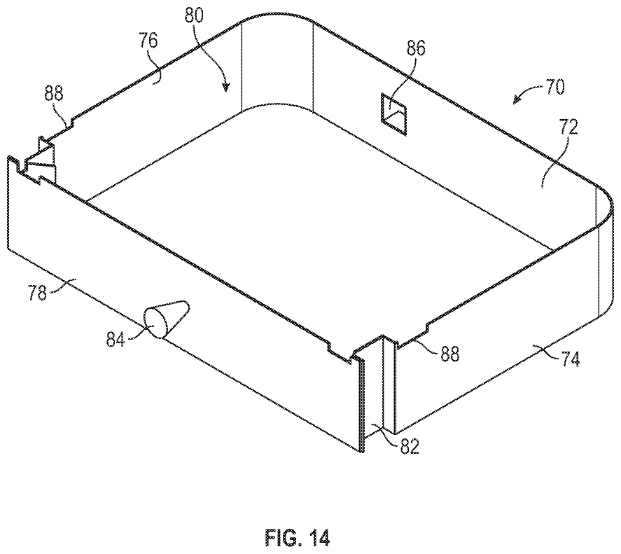

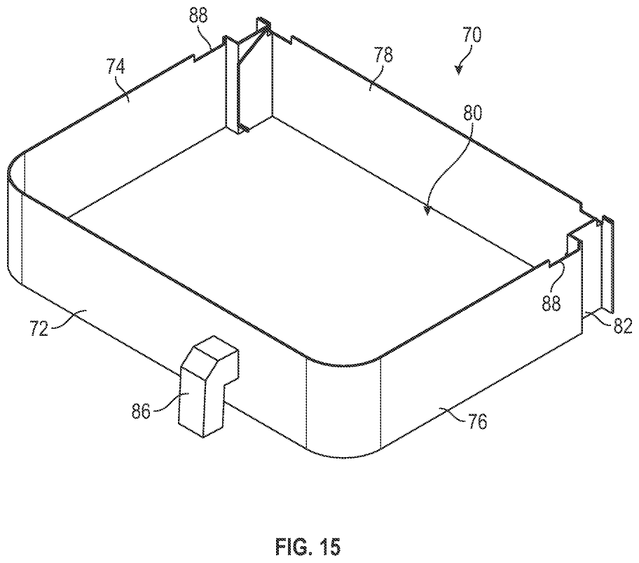

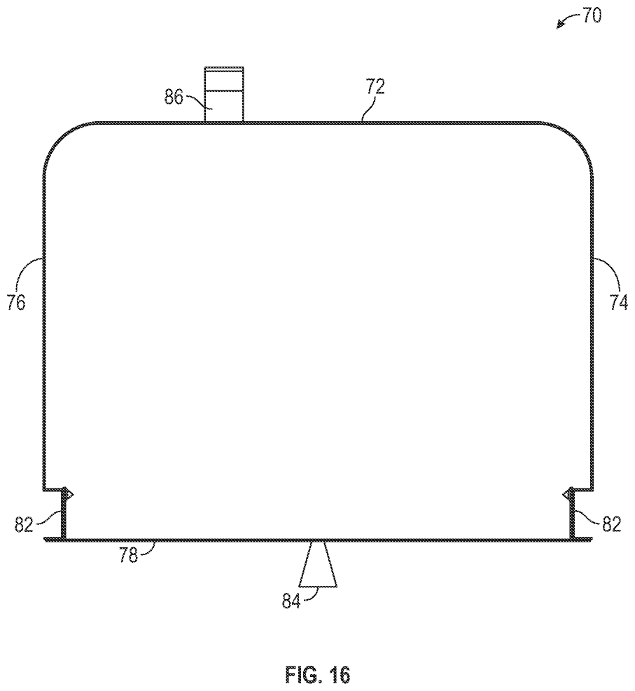

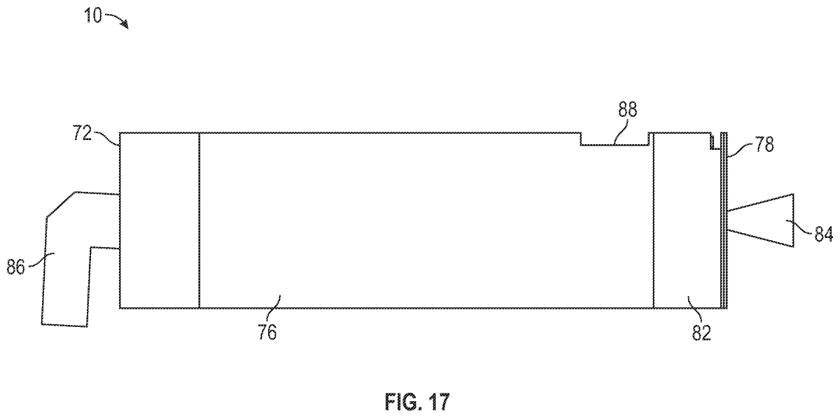

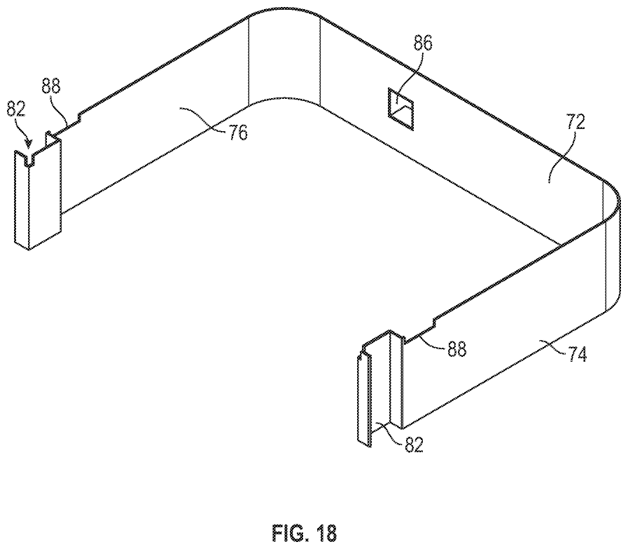

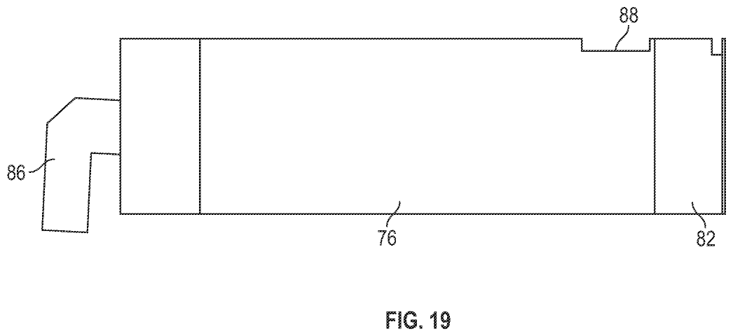

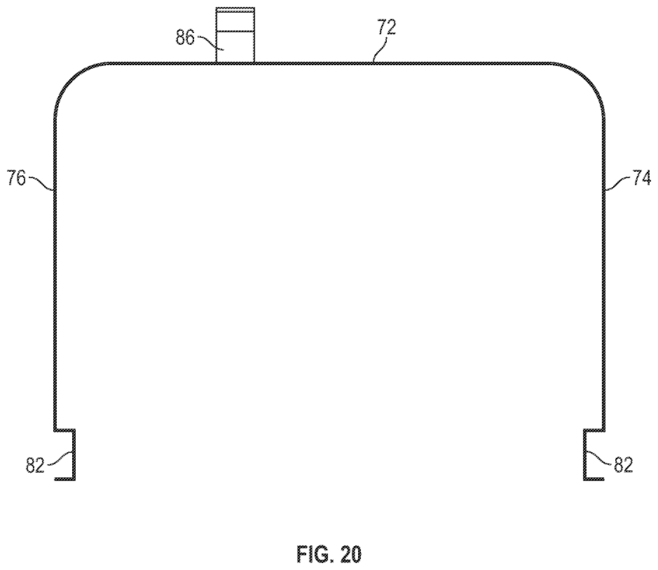

Turning to FIGS. 1-5 and 14-20, the cooking apparatus 10 also includes a removable frame assembly 70 that is selectively positionable on the lower heating surface 14. As best illustrated in FIGS. 14-20, the frame assembly 70 is generally rectangular in shape and includes a rear wall 72, opposing sidewalls 74, 76, and a front wall 78, which together define a cavity 80 therebetween (open on the top and bottom). Other peripheral shapes are also contemplated and within the scope of the present invention. The opposing sidewalls 74, 76 are also formed, adjacent to the forward ends thereof, with a locating recess or slot 82 which functions to reliably locate and retain the removable frame assembly 70 on the lower heating surface 14, as shown in FIGS. 1, 2, 9, 11 and 12. In an embodiment, the front wall 78 is configured for removable attachment to the opposing sidewalls 74, 76 and includes a gripping knob 84 suited for selectively attaching and/or removing the front wall 78. As best shown in FIGS. 15, 17 and 18, the rear wall 72 of the frame assembly 70 includes an opening or duct 86 configured for connected to the fan outlet duct 58 of the fan assembly 50.

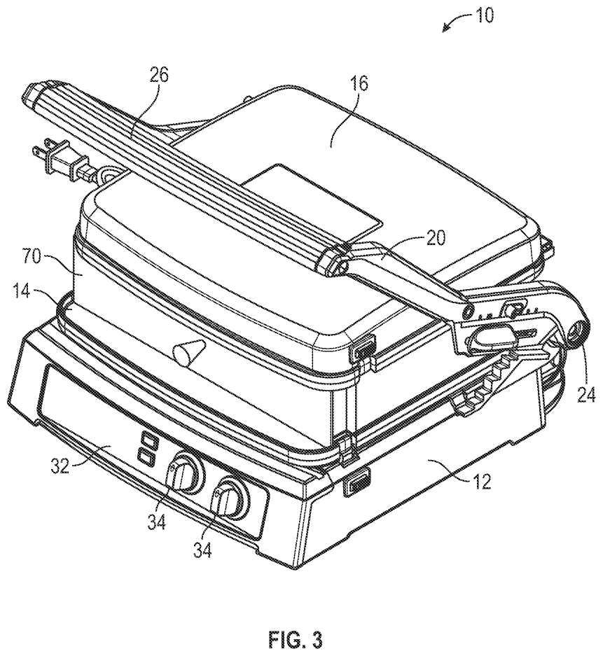

Referring back to FIG. 1, in operation, the upper housing 16 is rotated to the open position, and the frame assembly 70 is disposed on the lower heating surface 14. The locating slots 82 are engaged with the retention elements 19 so as to properly locate and retain the frame assembly 70 on the lower heating surface 14. As illustrated in FIGS. 3 and 4, the upper housing 16 can then be rotated about the hinge 24 so that the upper heating surface 16 rests upon the top edge of the frame assembly 70, enclosing cavity 80. In this position, the upper heating surface 18 is substantially parallel to the lower heating surface. As best shown in FIG. 4, in this position, the opening/duct 86 in the rear wall 72 of the frame assembly is in fluid communication with the fan 54 via duct 58.

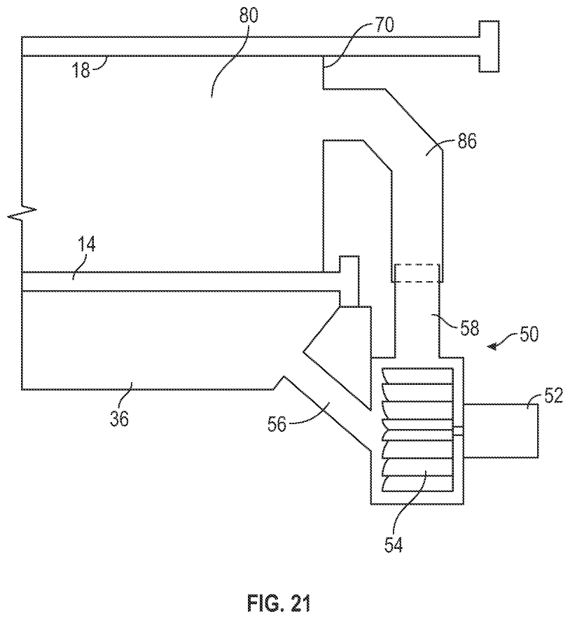

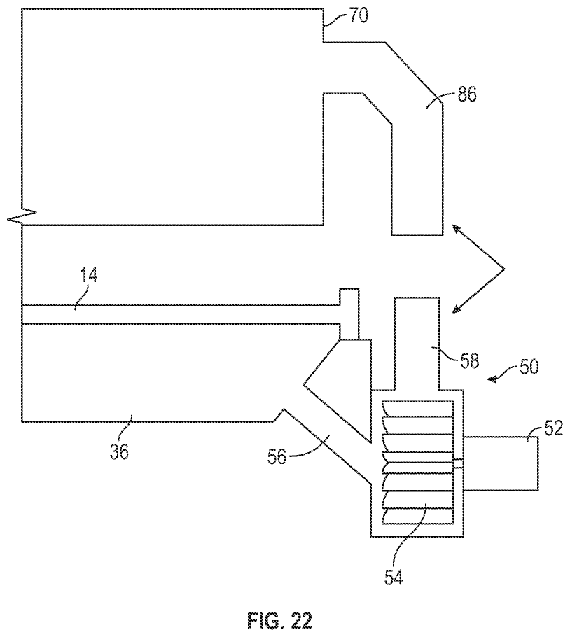

For example, as illustrated in FIG. 21, in an embodiment, the duct 58 extending from the fan assembly 50 may be mated with the duct/opening 86 extending from the rear wall 72 of the frame assembly so as to establish fluid communication between the fan 54 and the cavity 80 defined by the frame assembly 70. In an embodiment, the connection may be a male/female coupling, although other fluid connection means known in the art may also be utilized. In another embodiment, the duct 58 may extend entirely to the rear wall 72 of the frame assembly 70. FIG. 22 illustrates decoupling of the duct 58 from duct 86.

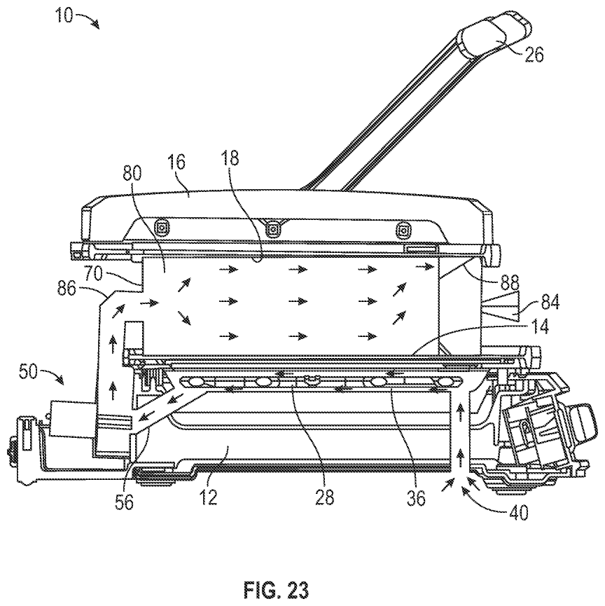

Referring now to FIG. 23, one or both of the heating elements 30 may be energized so as to produce heat, which heats the corresponding heating surfaces 14, 18 to cook a food item placed on the lower heating surface 14. In this cooking mode, the frame assembly 70, lower heating surface 14 and upper heating surface 18 enclose the food item in the cavity 80, enabling the cooking apparatus 10 to function like an oven to bake the food item.

Still further, the cooking apparatus 10 of the present invention is also operable in a convention cooking or air frying mode of operation. In such a mode, one or both of the heating elements 30 may be energized so as to produce heat, which heats the corresponding heating surfaces 14, 18. In contrast to the baking mode of operation, however, the motor 52 of the fan assembly 50 is also actuated to produce a flow of air through the cavity 80 and around the food item. Auction of the fan assembly can either be carried out manually, or via a processor of the cooking apparatus 10 operating according to a preprogrammed set of instructions and in response to initiation of such cooking mode by a user using the interface 32.

In particular, as illustrated in FIG. 23, when the motor 52 is actuated, it produces a rotational output that rotates/drives the fan 54. This draws ambient/outside air through the intake vent 40 in the bottom of the lower housing 12. The air then enters the plenum 36 within the lower housing 12 through air inlet 38, where is passes across the lower heating element(s) and is heated. The heated air exits the plenum 36 and enters the fan assembly 50 through inlet duct 56. The fan 54 then pushes this heated air upwards and into the cavity 80 formed by the frame assembly 70, where it passes across the space between the lower and upper heating surfaces 14, 18 and across the food item positioned therebetween. The air is then permitted to exit the cavity through outlets 88 in the forward end of the frame assembly 70 (e.g., through small apertures or reliefs in the sidewalls 74, 76. The airflow pathway is illustrated by the arrows in FIG. 23. In an embodiment, the intake 40 and/or the outlets 88 may include an associated filter for filtering particulates from the airflow.

In yet another cooking mode, the frame assembly 70 can be removed entirely, and the upper heating surface 18 and lower heating surface 16 can be positioned to directly contact a food item from above and below to provide for double contact grilling, as is known in the art. Alternatively, the upper housing 16 can be left in the open position so that just the lower heating surface 14 contacts the food item.

The cooking apparatus 10 of the present invention is therefore operable in a variety of cooking modes including one sided, direct contact grilling, double contact grilling, baking, and air frying or convection cooking.

While the present invention has been described as having an air plenum and fan assembly associated with the lower housing 12, it is not intended that the present invention be so limited in this regard. In particular, it is contemplated that the upper housing 12 may have an air intake and plenum for circulating and heating air to be flowed across a food item between the heating surfaces 14, 18. As alluded to above, in an embodiment, the fan may independently powered/controllable and can be shut off when using the cooking apparatus 10 in a grill or bake mode. In another embodiment, the cooking apparatus 10 may include an interlock switch that disables the air fry mode when the frame assembly 70 is not installed. In such an embodiment, the cooking apparatus 70 may include a spring-loaded or flexible flap which blocks off the lower portion of the duct 58 when the fan is not running, preventing particles/oil/etc. from entering the duct 58.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A cooking apparatus, comprising:
a lower housing having a lower heating surface;
an upper housing having an upper heating surface; and
a fan assembly configured to direct a flow of heated air into a space between the upper heating surface and the lower heating surface.

2. The cooking apparatus of claim 1, wherein:
at least one of the lower housing and the upper housing includes at least one heating element and plenum configured to direct a flow of air across the at least one heating element for heating the air to produce the heated air.

3. The cooking apparatus of claim 1, further comprising:
a frame assembly configured for positioning intermediate the lower heating surface and the upper heating surface and defining a cavity.

4. The cooking apparatus of claim 3, wherein:
the fan assembly includes a first duct configured for fluid communication with the plenum, and a second duct configured for fluid communication with the cavity defined by the frame assembly.

5. The cooking apparatus of claim 4, wherein:
the fan assembly includes a motor and an impeller.

6. The cooking apparatus of claim 4, wherein:
the second duct is configured to provide the heated air into the cavity through a rear wall of the cavity.

7. The cooking apparatus of claim 3, wherein:
the frame assembly includes a rear wall, a pair of opposing sidewalls, and a front wall.

8. The cooking apparatus of claim 7, wherein:
the front wall is removable from the sidewalls.

9. The cooking apparatus of claim 7, wherein:
at least one of the rear wall, opposed sidewalls and/or the front wall includes at least one aperture for egress of exhaust from the cavity.

10. The cooking apparatus of claim 2, wherein:
the lower housing includes the at least one heating element and the plenum; and
wherein the lower housing further includes an intake vent for ingress of air into the plenum.

11. The cooking apparatus of claim 3, wherein:
the frame assembly includes at least one locating member for interface with a corresponding feature on the lower heating surface to retain the frame assembly on the lower heating surface.

12. A method for operating a cooking appliance, comprising the steps of:
positioning a frame assembly intermediate a lower heating surface and an upper heating surface, the frame assembly defining a cooking cavity;
fluidly connecting the cooking cavity with a fan assembly; and
actuating a fan of the fan assembly to generate a flow of air into the cooking cavity.

13. The method according to claim 12, further comprising the step of:
removing a door of the frame assembly to access the cooking cavity.

14. The method according to claim 12, wherein:
the cooking appliance includes a lower housing supporting the lower heating surface, a plenum beneath the lower heating surface, and a heating element positioned within the plenum; and
wherein the fan assembly is in fluid communication with the plenum.

15. The method according to claim 12, further comprising the steps of:
lowering the upper heating surface towards the lower heating surface until the upper heating surface rests atop the frame assembly.

16. The method according to claim 14, wherein:
the step of actuating the fan causes a flow of air through an intake vent in a bottom surface of the lower housing and into the plenum.

17. A cooking appliance, comprising:
a lower housing having a lower heating surface, an intake vent, an air plenum in fluid communication with the intake vent, and at least one heating element associated with the air plenum;
an upper housing having an upper heating surface and moveable with respect to the lower housing; and
a fan assembly configured to initiate a flow of air into the air plenum through the intake vent, across the at least one heating element, and into a space intermediate the lower heating surface and the upper heating surface.

18. The cooking appliance of claim 17, further comprising:
a frame assembly configured for positioning intermediate the lower heating surface and the upper heating surface and defining a cavity.

19. The cooking apparatus of claim 18, wherein:
the fan assembly includes a first duct configured for fluid communication with the plenum, and a second duct configured for fluid communication with the cavity defined by the frame assembly.

20. The cooking appliance of claim 18, wherein:
the frame assembly includes a rear wall, a pair of opposing sidewalls, and a front wall, the rear wall having an opening for receiving the flow of air therethrough.
